(19) United States
(12) Patent Application Publication
(10) Pub. No.: US 2025/0390360 A1
(43) Pub. Date: Dec. 25, 2025

(54) METHOD FOR CONSTRUCTING AND PROCESSING A MACHINE LEARNING TASK, STORAGE MEDIUM AND ELECTRONIC APPARATUS

(71) Applicant: Beijing Volcano Engine Technology Co., Ltd., Haidian District (CN)

(72) Inventors: Jixi SHAN, Beijing (CN); Yang GUO, Beijing (CN); Hongyue MAO, Beijing (CN); Jun SONG, Beijing (CN); Rui SHI, Beijing (CN)

(21) Appl. No.: 19/069,492

(22) Filed: Mar. 4, 2025

(30) Foreign Application Priority Data
Jun. 20, 2024 (CN) 202410804620.4

(51) Int. Cl. G06F 9/52; G06N 20/00

(52) U.S. Cl. CPC G06F 9/52; G06N 20/00

(57) ABSTRACT

A method for constructing and processing a machine learning task, a storage medium and an electronic apparatus are provided. The method includes: obtaining sample data configuration information corresponding to the machine learning task; performing arrangement according to the sample data configuration information to obtain a task operation procedure diagram, wherein the task operation procedure diagram includes a plurality of operation sub-procedures, and one operation sub-procedure corresponds to one sub-interval of the target time interval, and is used to obtain sample data in a corresponding sub-interval from the target sample data source and determine machine learning task data based on the sample data; and controlling the plurality of operation sub-procedures to be executed in parallel based on the vertical joining, to obtain target machine learning task data with a vertical joining relationship, and constructing the machine learning task based on the target machine learning task data.

### CROSS-REFERENCE TO RELATED APPLICATION

The present application claims the priority of the Chinese patent application No. 202410804620.4 filed on Jun. 20, 2024, the entire contents of which are hereby incorporated by reference as a part of the present application.

### TECHNICAL FIELD

The present disclosure relates to the field of data processing technologies, and specifically, to a method for constructing and processing a machine learning task, a storage medium and an electronic apparatus.

### BACKGROUND

In a training phase of machine learning, training data suitable for machine learning needs to be determined from a large amount of data, to further construct a machine learning task based on the training data to perform model training.

In the related art, according to a sample data configuration, data needs to be sequentially processed (for example, through operations such as reading, conversion, and model training) according to service times corresponding to the data; that is, data lists for different time periods are sequentially obtained according to the sample data configuration in a single-thread manner, and a machine learning task is constructed according to the data lists. In this process, subsequent data can be processed only after previous data has been processed, which leads to a significant waste of time and underutilization of computational resources, resulting in a slow speed and low efficiency.

### SUMMARY

The Summary is provided to give a brief overview of concepts, which will be described in detail later in the Detailed Description section. The Summary is neither intended to identify key or necessary features of the claimed technical solutions, nor is it intended to be used to limit the scope of the claimed technical solutions.

According to at least one embodiment of the present disclosure, the present disclosure provides a method for constructing and processing a machine learning task. The method includes:

obtaining sample data configuration information corresponding to the machine learning task, wherein the sample data configuration information is used to indicate sample data generated by a target sample data source in a target time interval for training of the machine learning task;

performing arrangement according to the sample data configuration information to obtain a task operation procedure diagram, wherein the task operation procedure diagram comprises a plurality of operation sub-procedures which are arranged horizontally in a time order and configured with a vertical joining, and one operation sub-procedure of the plurality of operation sub-procedures corresponds to one sub-interval of the target time interval, and is used to obtain sample data in a corresponding sub-interval from the target sample data source and determine machine learning task data based on the sample data; and

controlling the plurality of operation sub-procedures to be executed in parallel based on the vertical joining, to obtain target machine learning task data with a vertical joining relationship, and constructing the machine learning task based on the target machine learning task data.

According to at least one embodiment of the present disclosure, the present disclosure provides a device for constructing and processing a machine learning task. The device includes:
an obtaining module configured to obtain sample data configuration information corresponding to the machine learning task, wherein the sample data configuration information is used to indicate sample data generated by a target sample data source in a target time interval for training of the machine learning task;
an arranging module configured to perform arrangement according to the sample data configuration information to obtain a task operation procedure diagram, wherein the task operation procedure diagram comprises a plurality of operation sub-procedures which are arranged horizontally in a time order and configured with a vertical joining, and one operation sub-procedure of the plurality of operation sub-procedures corresponds to one sub-interval of the target time interval, and is used to obtain sample data in a corresponding sub-interval from the target sample data source and determine machine learning task data based on the sample data; and
an execution module configured to control the plurality of operation sub-procedures to be executed in parallel based on the vertical joining, to obtain target machine learning task data with a vertical joining relationship, and constructing the machine learning task based on the target machine learning task data.

According to at least one embodiment of the present disclosure, the present disclosure provides non-transitory computer-readable storage medium storing a computer program thereon, where the computer program, when executed by at least one processor, causes the at least one processor to perform the method according to any one of the at least one embodiment of the present disclosure.

According to at least one embodiment of the present disclosure, the present disclosure provides an electronic apparatus. The electronic apparatus includes:
at least one processor; and
a non-transitory memory with instructions thereon, wherein the instructions upon execution by the at least one processor, cause the at least one processor to perform a method for constructing and processing a machine learning task according to any one of the at least one embodiment of the present disclosure.

According to at least one embodiment of the present disclosure, the present disclosure provides a computer program product including a computer program, where the computer program, when executed by a processor, causes the steps of the method according to any one of the at least one embodiment of the present disclosure to be implemented.

### BRIEF DESCRIPTION OF DRAWINGS

The foregoing and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale. In the figures:

FIG. 1 is a schematic diagram of a process of obtaining training data based on a single thread according to an exemplary embodiment of the present disclosure;

FIG. 2 is a schematic flowchart of a method for constructing and processing a machine learning task according to an exemplary embodiment of the present disclosure;

FIG. 3 is a schematic diagram of a task operation procedure diagram according to an exemplary embodiment of the present disclosure;

FIG. 4 is a schematic diagram of a task operation procedure diagram for a plurality of sample data sources according to an exemplary embodiment of the present disclosure;

FIG. 5 is a schematic diagram of a process of generating a task operation procedure diagram based on a logical flowchart according to an exemplary embodiment of the present disclosure;

FIG. 6 is a schematic diagram of data splitting according to an exemplary embodiment of the present disclosure;

FIG. 7 is a schematic diagram of operation isolation according to an exemplary embodiment of the present disclosure;

FIG. 8 is a schematic diagram of a process of constructing a machine learning task according to an exemplary embodiment of the present disclosure;

FIG. 9 is a block diagram of a structure of a device for constructing and processing a machine learning task according to an exemplary embodiment of the present disclosure; and

FIG. 10 is a schematic diagram of a structure of an electronic apparatus according to an exemplary embodiment of the present disclosure.

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel.

Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic apparatus, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic apparatus.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

Furthermore, it can be understood that the data involved in the technical solutions (including, but not limited to, the data itself and the access to or use of the data) shall comply with the requirements of corresponding laws, regulations, and relevant provisions.

A machine learning task of a machine learning model includes two parts: a training computation plane (Cluster) and a training data plane (Data). Each training computation plane corresponds to a model training computation resource topology created at a model startup phase, and different executors and the number of the executors in the topology are defined by the model. The training data plane usually includes a dataset (DataSet) and a dataset sample reading manner (DataLoader), where DataSet describes metadata of training data, for example, a file name, and DataLoader describes how to read training data from a file.

In the related art, data lists for different time periods are usually obtained sequentially according to a sample data configuration in a single-thread manner, and a machine learning task is constructed according to the data lists. Referring to FIG. 1, in an example of an actual application scenario, machine learning needs to be performed based on data of an application A and data of an application B, which means that data of a plurality of data sources needs to be obtained. In this case, a data list A of the application A and a data list B of the application B are separately obtained, and the data lists are performed a combined process based on the single-thread manner to generate a task description list. For example, a data list A1 and a data list B1 on March 1 are combined to obtain a training data list 1, and a data list A2 and a data list B2 on March 2 are combined to obtain a training data list 2. The data lists on March 2 need to be processed after the data lists on March 1 has been processed, which leads to a great waste of time and underutilization of computational resources, resulting in a slow speed and low efficiency.

Accordingly, even if a data list of a single data source is obtained and when a large amount of data is processed, the single-thread manner has also a slow speed and a low efficiency. In addition, a single thread is non-interruptible, a running result cannot be perceived before running end. In addition, subsequent data cannot be processed if a block occurs.

In view of this, the present disclosure provides a method and a device for constructing and processing a machine learning task, an electronic apparatus, a storage medium and a program product, to solve the above technical problems.

The embodiments of the present disclosure are further explained and described below with reference to the accompanying drawings.

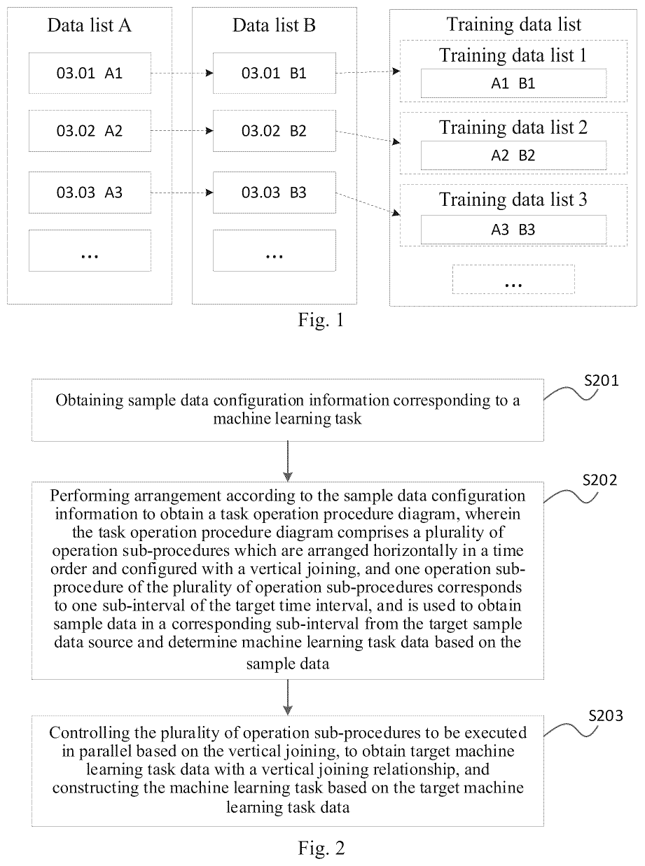

FIG. 2 is a flowchart of a method for constructing and processing a machine learning task according to an exemplary embodiment of the present disclosure. Referring to FIG. 2, the method includes the following steps S201˜S203.

S201: Obtaining sample data configuration information corresponding to a machine learning task.

The sample data configuration information is used to indicate sample data generated by a target sample data source in a target time interval for training of the machine learning task.

For example, a time interval corresponding to a data source A may be configured as Mar. 1, 2024 to May 1, 2024, and a time interval corresponding to a data source B may be configured as Feb. 1, 2024 to Apr. 1, 2024. The time interval may be specifically set as required and is not limited in the present disclosure.

S202: Performing arrangement according to the sample data configuration information to obtain a task operation procedure diagram, wherein the task operation procedure diagram includes a plurality of operation sub-procedures that are arranged horizontally in a time order and configured with a vertical joining, and one operation sub-procedure corresponds to one sub-interval of the target time interval, and is used for obtaining sample data in the corresponding sub-interval from the target sample data source and determining machine learning task data based on the sample data.

For example, division of sub-intervals of the target time interval may be performed by hour, day, week, month, or the like, which may be specifically set as required and is not limited in the present disclosure.

S203: Controlling the plurality of operation sub-procedures to be executed in parallel based on the vertical joining to obtain target machine learning task data with a vertical joining relationship, and constructing the machine learning task based on the target machine learning task data.

According to the above method, sample data of the target sample data source in different sub-intervals may be processed in parallel, each operation sub-procedure separately processes sample data in a corresponding sub-interval, and global output of the machine learning task is implemented based on the vertical joining between the plurality of operation sub-procedures, thereby making full use of computational resource, shortening idle waiting duration, and increasing a speed and efficiency of constructing the machine learning task.

In a possible manner, performing arrangement according to the sample data configuration information to obtain the task operation procedure diagram may include: determining the target sample data source and the target time interval according to the sample data configuration information; constructing the operation sub-procedures, where the operation sub-procedure is used to indicate to execute data processing according to ordered data processing operations corresponding to the target sample data source; dividing the target time interval into a plurality of sub-intervals which are continuous over time, and configuring a corresponding operation sub-procedure for each sub-interval, so that one sub-interval corresponds to one operation sub-procedure; and continuing to vertically join the plurality of operation sub-procedures respectively corresponding to the plurality of sub-intervals according to time, to construct the task operation procedure diagram.

For example, the target time interval may be divided into a plurality of temporally continuous sub-intervals based on a preset sample collection period corresponding to the target sample data source. For example, if data collection is performed for the data source A by hour, then division of time sub-intervals may be performed by hour. Alternatively, division of time sub-intervals may be performed based on a period longer than the preset sample collection period. For example, division of the time sub-intervals may be performed by day. Division is specifically set as required and is not limited in the present disclosure. Further, the corresponding operation sub-procedure is configured for each sub-interval, so that one sub-interval corresponds to one operation sub-procedure. Finally, all the operation sub-procedures are merged in a time order, and corresponding vertical joining dependencies are set to obtain the task operation procedure diagram.

Therefore, the sample data can be processed in parallel, thereby increasing a speed and efficiency of constructing the machine learning task.

In a possible manner, the sample data configuration information is used to indicate sample data generated by a plurality of target sample data sources in respective corresponding target time intervals for training of the machine learning task; and the constructing the operation sub-procedures may include: when a time intersection exists between the respective corresponding target time intervals of the plurality of target sample data sources, constructing data operation sub-procedures that each include an join operation, wherein the join operation is used to perform data joining on sample data in the time intersection that is from different target sample data sources.

For example, when there are a plurality of target sample data sources, division of time sub-intervals is performed according to a data source with a longer preset sample collection period. For example, if data collection is performed for the data source A by hour and data collection is performed for the data source B by day, division of time sub-intervals may be performed by day. Division is specifically set as required and is not limited in the present disclosure.

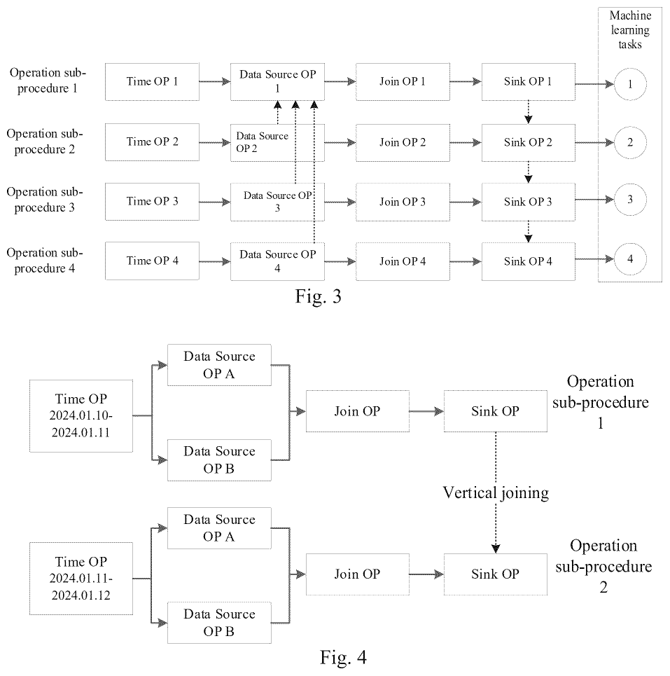

For example, when there is a time intersection between the respective corresponding target time intervals of the plurality of target sample data sources, an intersection time interval may be used as a common target time interval. For example, if the target time interval is (2024.01.10-2024.01.14), a time sub-interval 1 (2024.01.10-2024.01.11), a time sub-interval 2 (2024.01.11-2024.01.12), a time sub-interval 3 (2024.01.12-2024.01.13), and a time sub-interval 4 (2024.01.13-2024.01.14) are obtained through division by day, and four operation sub-procedures that include a join operation are constructed as shown in FIG. 3.

It should be noted that, as shown in FIG. 4, when there are a plurality of target sample data sources, there may be data source operations (Data Source OPs for short) in a one-to-one correspondence with the plurality of target sample data sources in each operation sub-procedure, that is, processes of requesting data from different target sample data sources may be performed through different data source operations.

In a possible manner, the sample data configuration information is used to indicate sample data generated by a plurality of target sample data sources in respective corresponding target time intervals for training of the machine learning task, and the operation sub-procedure includes a time operation, a data source operation, a join operation, and a sink operation that are sequentially connected; the time operation is used to determine a sub-interval corresponding to the operation sub-procedure; the data source operation is used to obtain sample data in the sub-interval from the plurality of target sample data sources; the join operation is used to perform data joining on a plurality of pieces of sample data obtained by executing the data source operation to obtain target joined data; and the sink operation is used to sink the target joined data and machine learning task data output by a previous operation sub-procedure of the operation sub-procedure, based on the vertical joining of the operation sub-procedure, to obtain machine learning task data that corresponds to the operation sub-procedure and has the vertical joining relationship.

For example, still referring to FIG. 3, when a plurality of target sample data sources are configured in the sample data configuration information and there is a time intersection between time intervals corresponding to the target sample data sources, the sample data configuration information is used to indicate sample data generated by a plurality of target sample data sources in respective corresponding target time intervals for training of the machine learning task. In this case, the operation sub-procedure includes a time operation (Time OP), a data source operation (Data Source OP), a join operation (Join OP), and a sink operation (Sink OP) that are sequentially connected.

It should be noted that the time operation corresponds to a time interval corresponding to the configured sample data sources. In addition, a logical time of the diagram may be further adjusted in a rewind or fast-forward manner based on a configuration. For example, Onetime Clock represents a configuration of executing the task operation procedure diagram once; Multi-Time Clock is applicable in a scenario in which there are a plurality of rounds of training, and may refer to a configuration of performing clock rewinding a plurality of times, that is, executing the task operation procedure diagram a plurality of times; and ToNow Clock represents continuous sending of “time control signaling” from a start time, which may be specifically set as required and is not limited in the present disclosure.

The data source operation is used to obtain the sample data from the plurality of target sample data sources in the time interval corresponding to the time operation. The join operation may be used to join the sample data obtained from the plurality of target sample data sources, for example, may join a plurality of pieces of batch data (BatchSource) or a plurality of pieces of stream data (StreamSource), or join one piece of batch data and one piece of stream data. The sample data source may be specifically set as required and is not limited in the present disclosure. In addition, when the sample data of the plurality of sample data sources needs to be joined, the join operation may be used to perform merge processing after the sample data corresponding to all the sample data sources is received, and release to a next operation. The sink operation may be used to sink the target joined data obtained through a previous operation, or establish data dependency between the target joined data and machine learning task data output by another concurrent operation sub-procedure, and align and output the two. The sink operation may be set as required and is not limited in the present disclosure.

For example, for one of the operation sub-procedures, still referring to FIG. 3, the time operation is executed first to determine a target sub-interval corresponding to the operation sub-procedure; and then the data source operation is executed to respectively obtain sample data whose generating time is in the target sub-interval from the plurality of target sample data sources, for example, obtain data A1 corresponding to the data source A and data B1 corresponding to the data source B, to obtain a plurality of pieces of sample data. Then, the join operation is executed to perform data joining on the plurality of pieces of sample data to obtain the target joined data. The plurality of pieces of sample data may be joined according to time, for example, the data A1 and the data B1 are data of a same day and are joined by hour, that is, A1-1 and B1-1 are joined and A1-2 and B1-2 are joined, and the like; or the data A1 and the data B1 are service data of a same user in different applications and may be joined according to the same user. Data joining is specifically set as required and is not limited in the present disclosure.

Finally, the sink operation is executed to directly sink and store the data obtained after the join operation, or sink and store, after secondary processing such as shuffling, time-based sorting, and sampling, the data obtained after the join operation, to obtain the machine learning task data corresponding to the operation sub-procedure. Alternatively, a dotted line process of the sink OP that is shown in FIG. 3 may be further used to sink and store the target joined data obtained after the join operation and the machine learning task data obtained through the previous operation sub-procedure of the operation sub-procedure, or sink and store, after secondary processing such as shuffling, time-based sorting, and sampling, the target joined data obtained after the join operation and the machine learning task data obtained through the previous operation sub-procedure of the operation sub-procedure, to obtain the machine learning task data corresponding to the operation sub-procedure, which are specifically set as required and are not limited in the present disclosure.

Complex execution of any a plurality of data sources is fine-grained based on the operation flowchart, fine-grained execution results are aggregated by establishing the join operation, local output and local shuffling of the finally constructed machine learning task are implemented by establishing the sink operation, and global sorting and global shuffling of the finally constructed machine learning task are implemented by establishing vertical joining dependencies between the sink operations.

In another possible manner, when there is a single target sample data source or there are a plurality of target sample data sources but there is no a time intersection between respective corresponding time intervals, an operation sub-procedure that does not include the join operation may be used to perform separate data processing on the plurality of target sample data sources to obtain machine learning task data. This may be determined as required and is not limited in the present disclosure.

In a possible manner, the sample data configuration information is used to indicate sample data generated by a single target sample data source in a target time interval for training of the machine learning task, and the operation sub-procedure includes a time operation, a data source operation, and a sink operation that are sequentially connected; the time operation is used to determine a sub-interval corresponding to the operation sub-procedure; the data source operation is used to obtain sample data in the sub-interval from the single target sample data source; and the sink operation is used to sink the sample data output by the data source operation and machine learning task data output through a previous operation sub-procedure of the operation sub-procedure, based on the vertical joining of the operation sub-procedure, to obtain machine learning task data that corresponds to the operation sub-procedure and has the vertical joining relationship.

For example, when a single target sample data source is configured in the sample data configuration information or a plurality of target sample data sources are configured in the sample data configuration information but there is no a time intersection between respective corresponding time intervals, the sample data configuration information is used to indicate sample data generated by a single target sample data source in a target time interval for training of the machine learning task, and the operation sub-procedure includes a time operation, a data source operation, and a sink operation that are sequentially connected, that is, sample data of each sample data source is separately processed and the join operation is not required. Separate data processing is also performed on the plurality of target sample data sources without a time intersection based on respective operation sub-procedures to obtain the machine learning task data.

It should be understood that a specific process may refer to an execution process of the operation sub-procedure including the join operation, and a difference lies in that each operation sub-procedure does not include a plurality of data source operations and does not include the join operation either, but other processing processes are the same. This is not described herein in the present disclosure again.

It should be noted that each operation sub-procedure separately outputs the machine learning task data. Compared with a single-thread manner, the present disclosure can perceive a running result before running of the entire operation flowchart ends. In addition, if one of the operation sub-procedures is blocked, running and output of other operation sub-procedures are not affected.

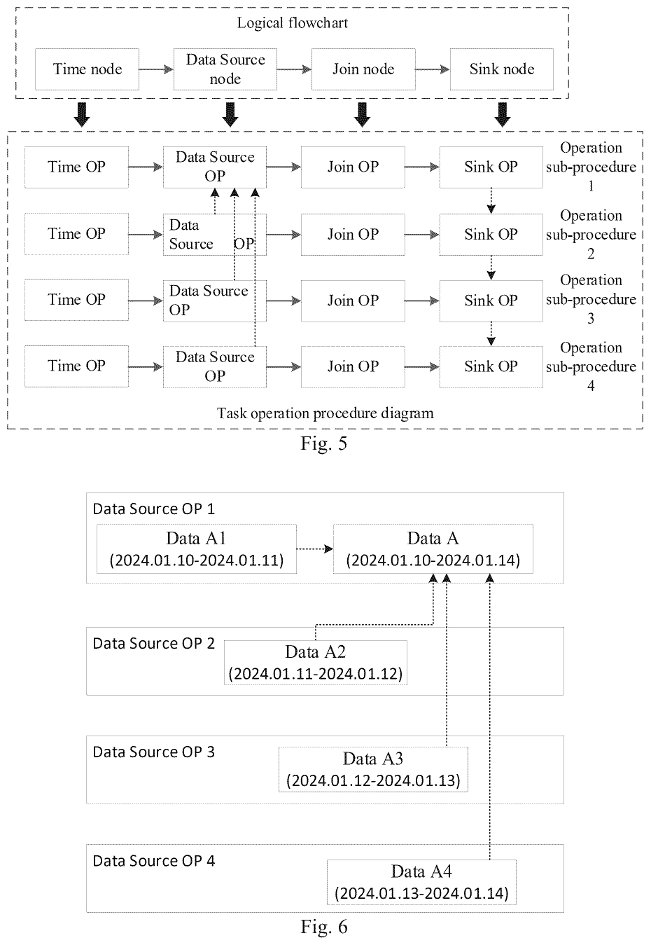

In another possible implementation, referring to FIG. 5, a logical flowchart may be first generated according to the target sample data source and the target time interval. The logical flowchart may include a time node, a data source node, a join node, and a sink node. Each node corresponds to one data operation type of the task operation procedure diagram. The time node is used to generate the time operation of the task operation procedure diagram, the data source node is used to generate the data source operation of the task operation procedure diagram, the join node is used to generate the join operation of the task operation procedure diagram, and the sink node is used to generate the sink operation of the task operation procedure diagram.

Then the logical flowchart may be optimized, for example, the join node of the logical flowchart is retained when there is a time intersection between the target time intervals respectively corresponding to the plurality of target sample data sources. Alternatively, the join node is deleted from the logical flowchart when there is a single target sample data source or there is no a time intersection between the target time intervals respectively corresponding to the plurality of target sample data sources.

For example, if a time interval corresponding to the data source A is (2024.01.01-2024.02.01) and a time interval corresponding to the data source B is (2024.01.15-2024.02.15), there is a time interval in which data of the two data sources overlaps, and data joining may be performed. Therefore, the join node is retained in the logical flowchart, that is, the task operation procedure diagram correspondingly includes operation of performing data joining. Otherwise, if there is only one data source or there is no time interval in which data of a plurality of data sources overlaps, data joining cannot be performed. Therefore, the join node is deleted from the logical flowchart, that is, the task operation procedure diagram correspondingly does not include the operations of performing data joining.

It should be noted that the logical flowchart including or not including the join node may alternatively be generated directly according to the above conditions. This is not limited in the present disclosure. A logical operation flow obtained based on the sample data configuration information can be visually shown by generating the logical flowchart. For ease of understanding or modification, the task operation procedure diagram for subsequently performing actual data processing is then generated. Unnecessary operations can be avoided by optimizing the logical flowchart, thereby increasing a speed and efficiency of constructing the machine learning task.

In a possible manner, the controlling the plurality of operation sub-procedures to be executed in parallel based on the vertical joining may include: executing a first operation sub-procedure in the plurality of operation sub-procedures to obtain all sample data in the target time interval from the target sample data source, and reading respective corresponding sample data from all the sample data according to the sub-intervals respectively corresponding to the plurality of operation sub-procedures; and controlling, according to the vertical joining, the plurality of operation sub-procedures to perform data processing in parallel based on the respective corresponding sample data.

For example, for small files, repeated obtaining for an hourly-level directory should be reduced as much as possible, for example, obtaining may be performed by day, and then hourly-level data is processed in each operation sub-procedure. Meta-information needs to be loaded when data is obtained from some data sources. To reduce the number of loading the meta-information, the data may also be obtained by day, and then hourly-level data is processed for each operation sub-procedure.

Still referring to FIG. 3, the operation sub-procedures are concurrently executed. All sample data of the target sample data source in the target time interval may be obtained through an operation sub-procedure 1; then all the sample data is divided into a plurality of pieces of sample data according to the sub-intervals; and then one operation sub-procedure performs data processing corresponding to sample data in one sub-interval, that is, a dotted line process of the data source OP that is shown in FIG. 3. This is specifically set as required and is not limited in the present disclosure.

It should be understood that sample data in a portion of the time intervals in the target time interval may alternatively be obtained first, for example, if the target time interval corresponding to the target sample data source is one month, data of one month may be obtained at a time and then the data is divided into a plurality of pieces of sub-data by day or hour, or the data may be obtained by day for a plurality of times and then data of one day is divided into a plurality of pieces of sub-data by hour. Then the operation sub-procedure performs data processing corresponding to sample data in one sub-interval. This is specifically set as required and is not limited in the present disclosure.

In addition, referring to FIG. 6, data obtaining and data splitting may be performed by one of the operation sub-procedures; or data obtaining may be performed through one of the operation sub-procedures and all sample data is obtained by the other operation sub-procedures from the operation sub-procedure and is split itself. This is specifically set as required and is not limited in the present disclosure. Therefore, computation fusion, computation reuse, and data splitting of the OP may be implemented, repeated computation is avoided, and resource waste is avoided.

The above process is equivalent to optimizing the task operation procedure diagram, thereby providing an OP-fused method for constructing a machine learning task, converting discrete and small-scale data obtaining manners into a fused data batch manner, and improving data processing efficiency. Based on the task operation procedure diagram, a horizontal dependency relationship of the machine learning task may be established, that is, a successive operation dependency relationship of each operation sub-procedure may be established; and vertical dependency relationships of training tasks may be further established, that is, the dotted line portions of the data source OPs and the sink OPs shown in FIG. 3. Therefore, concurrent control is implemented through management of operation execution queues.

Further, an execution process of the task operation procedure diagram may be further optimized based on a complexity of a data operation. In a possible manner, the method further includes: classifying operations in the operation sub-procedures in the task operation procedure diagram to obtain a first type of operations and a second type of operations, where a complexity of the first type of operations is greater than a complexity threshold, and a complexity of the second type of operations is not greater than the complexity threshold. In this case, the controlling the plurality of operation sub-procedures to be executed in parallel based on the vertical joining includes: executing the first type of operations in a first thread pool in a first-in first-out manner, and executing the second type of operations in a second thread pool in the first-in first-out manner, wherein an upper limit of concurrent data operations supported by the first thread pool is less than an upper limit of concurrent data operations supported by second thread pool.

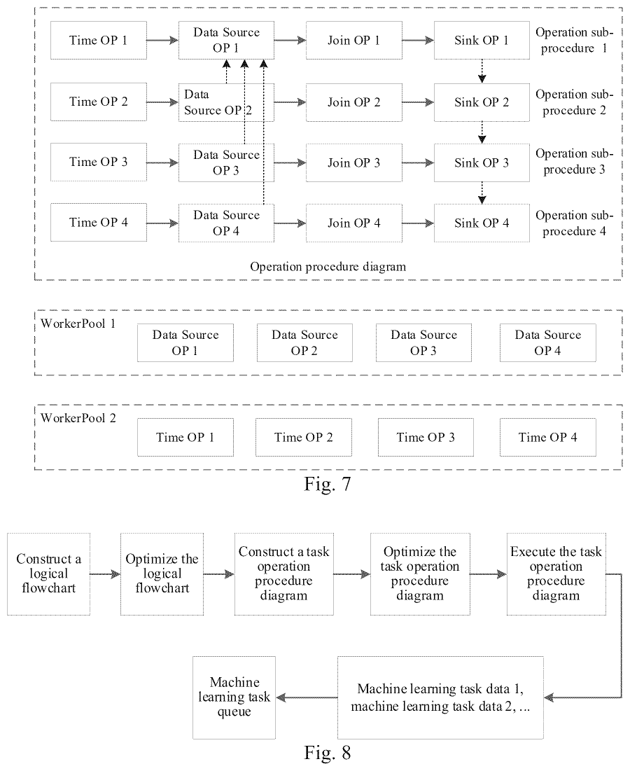

For example, referring to FIG. 7, different OPs may be isolated by setting different WorkerPools (or thread pools). For complex computational OPs such as the data source OP, a first thread pool WorkerPool 1 may be used for processing. For simple OPs such as the time OP, a second thread pool WorkerPool 2 is used for processing. An operation complexity may be determined based on time and resources consumed by computation. Usually, longer time and more resources consumed indicate a higher operation complexity. The complexity threshold may be set as required and is not limited in the present disclosure.

Upper limits of concurrent data operations that can be supported by WorkerPool 1 and WorkerPool 2 are different. For example, four data operations may be simultaneously executed in WorkerPool 1, and 64 data operations may be simultaneously executed in WorkerPool 2. There may be one or more first thread pools and one or more second thread pools. This is not limited in the present disclosure. Data operations in a same WorkerPool may be executed in a first-in first-out order, and balancing of computational resources and computational efficiency is implemented through a priority mechanism and an isolation mechanism of the data operations, thereby preventing training from being halted due to out-of-memory (OOM) caused by non-compressible resources such as a memory during computation.

In a possible manner, the method further includes: for each of the plurality of operation sub-procedures, determining, before a target data operation in each operation sub-procedure is executed, that a data operation before the target data operation has been completed, and releasing system resource occupied by the target data operation, after the target data operation is executed and when a data operation result of the target data operation is obtained by a next data operation.

For example, still referring to FIG. 3, for each operation sub-procedure, whether input of each OP is completed may be checked before the OP is executed. If the input of the OP is not completed, the OP is suspended to wait for an operation result of executing an upstream OP, a data operation result obtained after each OP is executed is cached, and the OP is marked as “completed”. Periodic cleanup is performed on an OP which has been completed OP and whose data operation result is obtained by all downstream OPs of the OP, to release occupied system resources, where the system resources may include at least one of resources such as memory resources, temporary file resources, CPU time, and network bandwidth resources.

It should be noted that, referring to FIG. 8, the logical flowchart is constructed based on the target sample data source and the target time interval corresponding to the target sample data source to further optimize the logical flowchart; then the task operation procedure diagram including a plurality of operation sub-procedures is constructed based on the logical flowchart to further optimize the task operation procedure diagram, including an execution priority and thread pool-based isolated execution of the OPs, unified obtaining, then splitting processing of data, and the like; and the task operation procedure diagram is executed to obtain the machine learning task data, and the machine learning task is constructed based on the machine learning task data to obtain a machine learning task queue.

According to the above method, sample data used for training of a machine learning model is organized and arranged, and the machine learning task is constructed in a manner of a large-scale OP diagram traversal, thereby constructing the machine learning task from sample metadata is achieved. In addition, sample data of different sample data sources in a same time interval may be arranged and data joining of sample data of a plurality of target data sources may be implemented, that is, one group of local machine learning task data based on a specific joining relationship is generated through input and output of one operation sub-procedure, to obtain a corresponding machine learning task list.

In addition, sample data in different time intervals also needs to be arranged to obtain a plurality of groups of machine learning task data to further obtain a plurality of groups of machine learning task lists, and secondary processing such as shuffling, time-based sorting, and sampling may be further performed on different machine learning task data. In addition, complex data operations, for example, the data source OP that requires a large amount of computational resources or storage resources for metadata scanning, are isolated by different WorkerPools to be executed, thereby avoiding overuse of resources, and improving stability of the task operation procedure diagram during execution. In addition, a concurrent execution mechanism of the data operations is implemented based on the WorkerPools, so that an execution speed of the operation sub-procedures is accelerated, thereby increasing a speed and efficiency of constructing the machine learning task.

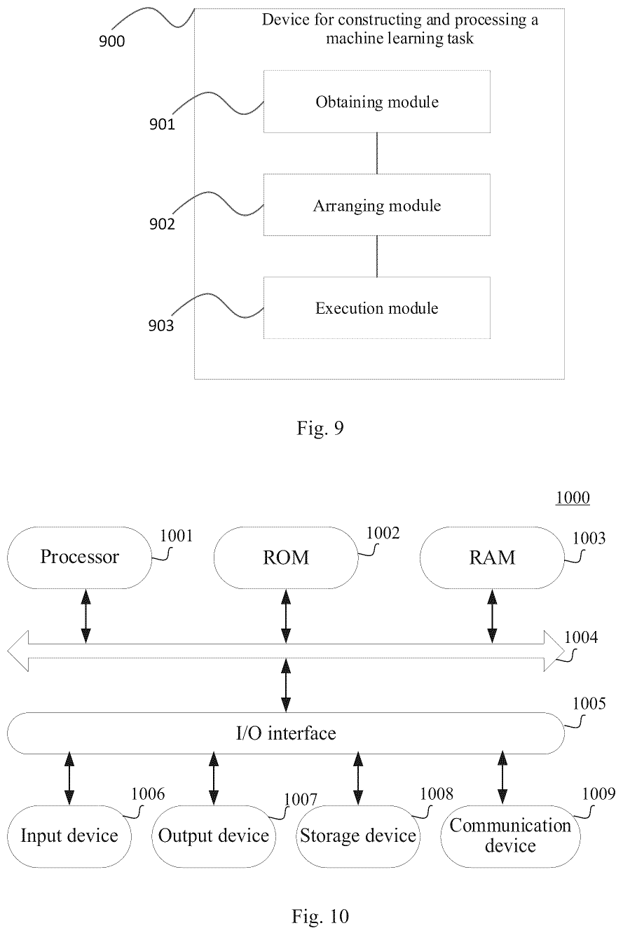

Based on the same concept, an embodiment of the present disclosure further provides a device for constructing and processing a machine learning task. As shown in FIG. 9, a device 900 for constructing and processing a machine learning task includes:

an obtaining module 901 configured to obtain sample data configuration information corresponding to the machine learning task, wherein the sample data configuration information is used to indicate sample data generated by a target sample data source in a target time interval for training of the machine learning task;

an arranging module 902 configured to perform arrangement according to the sample data configuration information to obtain a task operation procedure diagram, wherein the task operation procedure diagram includes a plurality of operation sub-procedures that are arranged horizontally in a time order and configured with a vertical joining, and one operation sub-procedure corresponds to one sub-interval of the target time interval, and is used for obtaining sample data in the corresponding sub-interval from the target sample data source and determining machine learning task data based on the sample data; and

an execution module 903 configured to control the plurality of operation sub-procedures to be executed in parallel based on the vertical joining to obtain target machine learning task data with a vertical joining relationship, and construct the machine learning task based on the target machine learning task data.

Optionally, the arranging module 902 includes:
a determination module configured to determine the target sample data source and the target time interval according to the sample data configuration information;
a first construction module configured to construct the operation sub-procedures, wherein the operation sub-procedures are used to indicate to execute data processing according to ordered data processing operations corresponding to the target sample data source;
a division module configured to divide the target time interval into a plurality of temporally continuous sub-intervals, and configure a corresponding operation sub-procedure for each sub-interval, so that one sub-interval corresponds to one operation sub-procedure; and
a second construction module configured to continuing to vertically join the plurality of operation sub-procedures respectively corresponding to the plurality of sub-intervals according to time, to construct the task operation procedure diagram.

Optionally, the sample data configuration information is used to indicate sample data generated by a plurality of target sample data sources in respective corresponding target time intervals for training of the machine learning task; and the first construction module is configured to:

when a time intersection exists between the respective corresponding target time intervals of the plurality of target sample data sources, construct data operation sub-procedures that include a join operation, wherein the join operation is used to perform data joining on sample data in the time intersection that is from different target sample data sources.

Optionally, the sample data configuration information is used to indicate sample data generated by a plurality of target sample data sources in respective corresponding target time intervals for training of the machine learning task, and the operation sub-procedure includes a time operation, a data source operation, a join operation, and a sink operation that are sequentially connected;

the time operation is used to determine a sub-interval corresponding to the operation sub-procedure; the data source operation is used to obtain sample data in the sub-interval from the plurality of target sample data sources; the join operation is used to perform data joining on a plurality of pieces of sample data obtained by executing the data source operation to obtain target joined data; and the sink operation is used to sink the target joined data and machine learning task data output through a previous operation sub-procedure of the operation sub-procedure, based on the vertical joining of the operation sub-procedure, to obtain machine learning task data that corresponds to the operation sub-procedure and has the vertical joining relationship.

Optionally, the sample data configuration information is used to indicate sample data generated by a single target sample data source in a target time interval for training of the machine learning task, and the operation sub-procedure includes a time operation, a data source operation, and a sink operation that are sequentially connected;

the time operation is used to determine a sub-interval corresponding to the operation sub-procedure; the data source operation is used to obtain sample data in the sub-interval from the single target sample data source; and the sink operation is used to sink the sample data output by the data source operation and machine learning task data output through a previous operation sub-procedure of the operation sub-procedure, based on the vertical joining of the operation sub-procedure, to obtain machine learning task data that corresponds to the operation sub-procedure and has the vertical joining relationship.

Optionally, the execution module 903 is configured to:
execute a first operation sub-procedure in the plurality of operation sub-procedures to obtain all sample data in the target time interval from the target sample data source, and read respective sample data from all the sample data according to the sub-intervals respectively corresponding to the plurality of operation sub-procedures; and
control, according to the vertical joining, the plurality of operation sub-procedures to perform data processing in parallel based on the respective corresponding sample data.

Optionally, the device 900 for constructing and processing a machine learning task further includes:
a classification module configured to classify operations in the operation sub-procedures in the task operation procedure diagram to obtain a first type of operations and a second type of operations, where a complexity of the first type of operations is greater than a complexity threshold, and a complexity of the second type of operations is not greater than the complexity threshold.

In this case, the execution module 903 is configured to:
execute the first type of operations in a first thread pool in a first-in first-out manner, and execute the second type of operations in a second thread pool in the first-in first-out manner, wherein an upper limit of concurrent data operations supported by the first thread pool is less than an upper limit of concurrent data operations supported by second thread pool.

Optionally, the device 900 for constructing and processing a machine learning task further includes:
a releasing module configured to for each of operation sub-procedure and before a target data operation in the operation sub-procedure is executed, determine that a data operation before the target data operation has been completed, and release system resources occupied by the target data operation, after the target data operation is executed and when an operation result of the target data operation has been obtained by a next data operation.

Based on the same concept, an embodiment of the present disclosure further provides a computer-readable storage medium having a computer program stored thereon, where the program, when executed by at least one processor, causes the steps of the method for constructing and processing a machine learning task described above to be implemented.

Based on the same concept, an embodiment of the present disclosure further provides an electronic apparatus. The electronic apparatus may include:
a memory having a computer program stored thereon; and
at least one processor configured to execute the computer program in the memory to implement the steps of the method for constructing and processing a machine learning task described above.

Based on the same concept, an embodiment of the present disclosure further provides a computer program product including a computer program, where the computer program, when executed by at least one processor, causes the steps of the method for constructing and processing a machine learning task described above to be implemented.

Reference is made to FIG. 10 below, which is a schematic diagram of a structure of an electronic apparatus 1000 suitable for implementing an embodiment of the present disclosure. A terminal apparatus in this embodiment of the present disclosure may include, but is not limited to, mobile terminals such as a mobile phone, a notebook computer, a digital broadcast receiver, a personal digital assistant (PDA), a tablet computer (PAD), a portable media player (PMP), and a vehicle-mounted terminal (e.g., a vehicle navigation terminal), and fixed terminals such as a digital TV and a desktop computer. The electronic apparatus shown in FIG. 10 is merely an example, and shall not impose any limitation on the function and scope of use of the embodiments of the present disclosure.

As shown in FIG. 10, the electronic apparatus 1000 may include a processor (e.g., a central processing unit or a graphics processing unit) 1001 that may perform a variety of appropriate actions and processing in accordance with a program stored in a read-only memory (ROM) 1002 or a program loaded from a storage device 1008 into a random access memory (RAM) 1003. The RAM 1003 further stores various programs and data required for the operation of the electronic apparatus 1000. The processor 1001, the ROM 1002, and the RAM 1003 are connected to one another through a bus 1004. An input/output (I/O) interface 1005 is also connected to the bus 1004.

Generally, the following devices may be connected to the I/O interface 1005: an input device 1006 including, for example, a touchscreen, a touchpad, a keyboard, a mouse, a camera, a microphone, an accelerometer, and a gyroscope; an output device 1007 including, for example, a liquid crystal display (LCD), a speaker, and a vibrator; the storage device 1008 including, for example, a tape and a hard disk; and a communication device 1009. The communication device 1009 may allow the electronic apparatus 1000 to perform wireless or wired communication with other devices to exchange data. Although FIG. 10 shows the electronic apparatus 1000 having various devices, it should be understood that it is not required to implement or have all of the shown devices. It may be an alternative to implement or have more or fewer devices.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication device 1009, installed from the storage device 1008, or installed from the ROM 1002. When the computer program is executed by the processor 1001, the above-mentioned functions defined in the method of the embodiment of the present disclosure are performed.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM) (or a flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, communication may be performed using any currently known or future-developed network protocol such as a hypertext transfer protocol (HTTP), and interconnection with digital data communication (e.g., a communication network) in any form or medium may be achieved. Examples of the communication network include a local area network (“LAN”), a wide area network (“WAN”), an internetwork (for example, the Internet), a peer-to-peer network (for example, an ad hoc peer-to-peer network), and any currently known or future-developed network.

The above computer-readable storage medium may be contained in the above electronic apparatus. Alternatively, the computer-readable storage medium may exist independently, without being assembled into the electronic apparatus.

The above computer-readable storage medium carries one or more programs that, when executed by the electronic apparatus, cause the electronic apparatus to: obtain sample data configuration information corresponding to the machine learning task, wherein the sample data configuration information is used to indicate sample data generated by a target sample data source in a target time interval for training of the machine learning task; perform arrangement according to the sample data configuration information to obtain a task operation procedure diagram, wherein the task operation procedure diagram includes a plurality of operation sub-procedures that are arranged horizontally in a time order and configured with a vertical joining, and one operation sub-procedure corresponds to one sub-interval of the target time interval, and is used for obtaining sample data in the corresponding sub-interval from the target sample data source and determining machine learning task data based on the sample data; and control the plurality of operation sub-procedures to be executed in parallel based on the vertical joining to obtain target machine learning task data with a vertical joining relationship, and construct the machine learning task based on the target machine learning task data.

The computer program code for performing the operations of the present disclosure may be written in one or more programming languages or a combination thereof, where the programming languages include, but are not limited to, an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The modules described in the embodiments of the present disclosure may be implemented by software, or may be implemented by hardware. The names of the modules in a certain scenario do not constitute a limitation on the modules themselves.

The functions described herein above may be performed at least partially by one or more hardware logic components. For example, without limitation, exemplary types of hardware logic components that may be used include: a field programmable gate array (FPGA), an application-specific integrated circuit (ASIC), an application-specific standard product (ASSP), a system-on-chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

The foregoing descriptions are merely exemplary embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls in the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable sub-combination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims. With respect to the apparatus in the above embodiments, the specific manner in which each module performs an operation has been described in detail in the embodiments relating to the method, and will not be detailed herein.

1. A method for constructing and processing a machine learning task, the method comprising:
obtaining sample data configuration information corresponding to the machine learning task, wherein the sample data configuration information is used to indicate sample data generated by a target sample data source in a target time interval for training of the machine learning task;
performing arrangement according to the sample data configuration information to obtain a task operation procedure diagram, wherein the task operation procedure diagram comprises a plurality of operation sub-procedures which are arranged horizontally in a time order and configured with a vertical joining, and one operation sub-procedure of the plurality of operation sub-procedures corresponds to one sub-interval of the target time interval, and is used to obtain sample data in a corresponding sub-interval from the target sample data source and determine machine learning task data based on the sample data; and
controlling the plurality of operation sub-procedures to be executed in parallel based on the vertical joining, to obtain target machine learning task data with a vertical joining relationship, and constructing the machine learning task based on the target machine learning task data.

2. The method according to claim 1, wherein the performing arrangement according to the sample data configuration information to obtain a task operation procedure diagram comprises:
determining the target sample data source and the target time interval according to the sample data configuration information;
constructing the plurality of operation sub-procedures, wherein each of the plurality of operation sub-procedures is used to indicate to execute data processing according to ordered data processing operations corresponding to the target sample data source;
dividing the target time interval into a plurality of sub-intervals which are continuous over time, and configuring a corresponding operation sub-procedure for each of the plurality of sub-intervals, so that one sub-interval corresponds to one operation sub-procedure; and
continuing to vertically join the plurality of operation sub-procedures respectively corresponding to the plurality of sub-intervals according to time, to construct the task operation procedure diagram.

3. The method according to claim 2, wherein the sample data configuration information is used to indicate sample data generated by a plurality of target sample data sources in respective corresponding target time intervals for training of the machine learning task; and
the constructing the plurality of operation sub-procedures comprises:
when a time intersection exists between the respective corresponding target time intervals of the plurality of target sample data sources, constructing a data operation sub-procedure comprising a join operation, wherein the join operation is used to perform data joining on sample data in the time intersection which is from different target sample data sources.

4. The method according to claim 1, wherein the sample data configuration information is used to indicate sample data generated by a plurality of target sample data sources in respective corresponding target time intervals for training of the machine learning task, and the operation sub-procedure comprises a time operation, a data source operation, a join operation, and a sink operation which are sequentially connected; and
the time operation is used to determine a sub-interval corresponding to the operation sub-procedure; the data source operation is used to acquire sample data in the sub-interval from the plurality of target sample data sources; the join operation is used to perform data joining on a plurality of pieces of sample data obtained by executing the data source operation to obtain target joined data; and the sink operation is used to sink the target joined data and machine learning task data output by a previous operation sub-procedure of the operation sub-procedure, based on the vertical joining of the operation sub-procedure, to obtain machine learning task data which corresponds to the operation sub-procedure and has the vertical joining relationship.

5. The method according to claim 1, wherein the sample data configuration information is used to indicate sample data generated by a single target sample data source in a target time interval for training of the machine learning task, and the operation sub-procedure comprises a time operation, a data source operation, and a sink operation which are sequentially connected; and
the time operation is used to determine a sub-interval corresponding to the operation sub-procedure; the data source operation is used to obtain sample data in the sub-interval from the single target sample data source; and the sink operation is used to sink the sample data output by the data source operation and machine learning task data output by a previous operation sub-procedure of the operation sub-procedure, based on the vertical joining of the operation sub-procedure, to obtain machine learning task data which corresponds to the operation sub-procedure and has the vertical joining relationship.

6. The method according to claim 1, wherein the controlling the plurality of operation sub-procedures to be executed in parallel based on the vertical joining comprises:
executing a first operation sub-procedure in the plurality of operation sub-procedures, to obtain all sample data in the target time interval from the target sample data source, and reading respective corresponding sample data from the all sample data according to the sub-intervals respectively corresponding to the plurality of operation sub-procedures; and
according to the vertical joining, controlling the plurality of operation sub-procedures to execute data processing in parallel based on the respective corresponding sample data.

7. The method according to claim 1, further comprising:
classifying operations in the plurality of operation sub-procedures in the task operation procedure diagram to obtain a first type of operations and a second type of operations, wherein a complexity of the first type of operations is greater than a complexity threshold, and a complexity of the second type of operations is not greater than the complexity threshold; and
the controlling the plurality of operation sub-procedures to be executed in parallel based on the vertical joining comprises:
executing the first type of operations in a first thread pool in a first-in first-out manner, and executing the second type of operations in a second thread pool in the first-in first-out manner, wherein an upper limit of concurrent data operations supported by the first thread pool is less than an upper limit of concurrent data operations supported by second thread pool.

8. The method according to claim 1, further comprising:
for each of the plurality of operation sub-procedures, before a target data operation in the operation sub-procedure is executed, determining that execution of a data operation before the target data operation is completed, and after the target data operation is executed and when an operation result of the target data operation is obtained by a next data operation, releasing system resource occupied by the target data operation.

9. A non-transitory computer-readable storage medium storing a computer program thereon, wherein the computer program, when executed by at least one processor, causes the at least one processor to perform a method for constructing and processing a machine learning task, and the method comprises:
obtaining sample data configuration information corresponding to the machine learning task, wherein the sample data configuration information is used to indicate sample data generated by a target sample data source in a target time interval for training of the machine learning task;
performing arrangement according to the sample data configuration information to obtain a task operation procedure diagram, wherein the task operation procedure diagram comprises a plurality of operation sub-procedures which are arranged horizontally in a time order and configured with a vertical joining, and one operation sub-procedure of the plurality of operation sub-procedures corresponds to one sub-interval of the target time interval, and is used to obtain sample data in a corresponding sub-interval from the target sample data source and determine machine learning task data based on the sample data; and
controlling the plurality of operation sub-procedures to be executed in parallel based on the vertical joining, to obtain target machine learning task data with a vertical joining relationship, and constructing the machine learning task based on the target machine learning task data.

10. The storage medium according to claim 9, wherein the performing arrangement according to the sample data configuration information to obtain a task operation procedure diagram comprises:
determining the target sample data source and the target time interval according to the sample data configuration information;
constructing the plurality of operation sub-procedures, wherein each of the plurality of operation sub-procedures is used to indicate to execute data processing according to ordered data processing operations corresponding to the target sample data source;
dividing the target time interval into a plurality of sub-intervals which are continuous over time, and configuring a corresponding operation sub-procedure for each of the plurality of sub-intervals, so that one sub-interval corresponds to one operation sub-procedure; and
continuing to vertically join the plurality of operation sub-procedures respectively corresponding to the plurality of sub-intervals according to time, to construct the task operation procedure diagram.

11. The storage medium according to claim 10, wherein the sample data configuration information is used to indicate sample data generated by a plurality of target sample data sources in respective corresponding target time intervals for training of the machine learning task; and
the constructing the plurality of operation sub-procedures comprises:
when a time intersection exists between the respective corresponding target time intervals of the plurality of target sample data sources, constructing a data operation sub-procedure comprising a join operation, wherein the join operation is used to perform data joining on sample data in the time intersection which is from different target sample data sources.

12. The storage medium according to claim 9, wherein the sample data configuration information is used to indicate sample data generated by a plurality of target sample data sources in respective corresponding target time intervals for training of the machine learning task, and the operation sub-procedure comprises a time operation, a data source operation, a join operation, and a sink operation which are sequentially connected; and
the time operation is used to determine a sub-interval corresponding to the operation sub-procedure; the data source operation is used to acquire sample data in the sub-interval from the plurality of target sample data sources; the join operation is used to perform data joining on a plurality of pieces of sample data obtained by executing the data source operation to obtain target joined data; and the sink operation is used to sink the target joined data and machine learning task data output by a previous operation sub-procedure of the operation sub-procedure, based on the vertical joining of the operation sub-procedure, to obtain machine learning task data which corresponds to the operation sub-procedure and has the vertical joining relationship.

13. An electronic apparatus, comprising:
at least one processor; and
a memory with instructions thereon,
wherein the instructions upon execution by the at least one processor, cause the at least one processor to perform a method for constructing and processing a machine learning task, and the method comprises:
obtaining sample data configuration information corresponding to the machine learning task, wherein the sample data configuration information is used to indicate sample data generated by a target sample data source in a target time interval for training of the machine learning task;
performing arrangement according to the sample data configuration information to obtain a task operation procedure diagram, wherein the task operation procedure diagram comprises a plurality of operation sub-procedures which are arranged horizontally in a time order and configured with a vertical joining, and one operation sub-procedure of the plurality of operation sub-procedures corresponds to one sub-interval of the target time interval, and is used to obtain sample data in a corresponding sub-interval from the target sample data source and determine machine learning task data based on the sample data; and
controlling the plurality of operation sub-procedures to be executed in parallel based on the vertical joining, to obtain target machine learning task data with a vertical joining relationship, and constructing the machine learning task based on the target machine learning task data.

14. The electronic apparatus according to claim 13, wherein the performing arrangement according to the sample data configuration information to obtain a task operation procedure diagram comprises:
determining the target sample data source and the target time interval according to the sample data configuration information;
constructing the plurality of operation sub-procedures, wherein each of the plurality of operation sub-procedures is used to indicate to execute data processing according to ordered data processing operations corresponding to the target sample data source;
dividing the target time interval into a plurality of sub-intervals which are continuous over time, and configuring a corresponding operation sub-procedure for each of the plurality of sub-intervals, so that one sub-interval corresponds to one operation sub-procedure; and
continuing to vertically join the plurality of operation sub-procedures respectively corresponding to the plurality of sub-intervals according to time, to construct the task operation procedure diagram.

15. The electronic apparatus according to claim 14, wherein the sample data configuration information is used to indicate sample data generated by a plurality of target sample data sources in respective corresponding target time intervals for training of the machine learning task; and
the constructing the plurality of operation sub-procedures comprises:
when a time intersection exists between the respective corresponding target time intervals of the plurality of target sample data sources, constructing a data operation sub-procedure comprising a join operation, wherein the join operation is used to perform data joining on sample data in the time intersection which is from different target sample data sources.

16. The electronic apparatus according to claim 13, wherein the sample data configuration information is used to indicate sample data generated by a plurality of target sample data sources in respective corresponding target time intervals for training of the machine learning task, and the operation sub-procedure comprises a time operation, a data source operation, a join operation, and a sink operation which are sequentially connected; and
the time operation is used to determine a sub-interval corresponding to the operation sub-procedure; the data source operation is used to acquire sample data in the sub-interval from the plurality of target sample data sources; the join operation is used to perform data joining on a plurality of pieces of sample data obtained by executing the data source operation to obtain target joined data; and the sink operation is used to sink the target joined data and machine learning task data output by a previous operation sub-procedure of the operation sub-procedure, based on the vertical joining of the operation sub-procedure, to obtain machine learning task data which corresponds to the operation sub-procedure and has the vertical joining relationship.

17. The electronic apparatus according to claim 13, wherein the sample data configuration information is used to indicate sample data generated by a single target sample data source in a target time interval for training of the machine learning task, and the operation sub-procedure comprises a time operation, a data source operation, and a sink operation which are sequentially connected; and
the time operation is used to determine a sub-interval corresponding to the operation sub-procedure; the data source operation is used to obtain sample data in the sub-interval from the single target sample data source; and the sink operation is used to sink the sample data output by the data source operation and machine learning task data output by a previous operation sub-procedure of the operation sub-procedure, based on the vertical joining of the operation sub-procedure, to obtain machine learning task data which corresponds to the operation sub-procedure and has the vertical joining relationship.

18. The electronic apparatus according to claim 13, wherein the controlling the plurality of operation sub-procedures to be executed in parallel based on the vertical joining comprises:
executing a first operation sub-procedure in the plurality of operation sub-procedures, to obtain all sample data in the target time interval from the target sample data source, and reading respective corresponding sample data from the all sample data according to the sub-intervals respectively corresponding to the plurality of operation sub-procedures; and
according to the vertical joining, controlling the plurality of operation sub-procedures to execute data processing in parallel based on the respective corresponding sample data.

19. The electronic apparatus according to claim 13, wherein the method further comprises:
classifying operations in the plurality of operation sub-procedures in the task operation procedure diagram to obtain a first type of operations and a second type of operations, wherein a complexity of the first type of operations is greater than a complexity threshold, and a complexity of the second type of operations is not greater than the complexity threshold; and
the controlling the plurality of operation sub-procedures to be executed in parallel based on the vertical joining comprises:
executing the first type of operations in a first thread pool in a first-in first-out manner, and executing the second type of operations in a second thread pool in the first-in first-out manner, wherein an upper limit of concurrent data operations supported by the first thread pool is less than an upper limit of concurrent data operations supported by second thread pool.

20. The electronic apparatus according to claim 13, wherein the method further comprises:
for each of the plurality of operation sub-procedures, before a target data operation in the operation sub-procedure is executed, determining that execution of a data operation before the target data operation is completed, and after the target data operation is executed and when an operation result of the target data operation is obtained by a next data operation, releasing system resource occupied by the target data operation.
